(19) United States
(12) Patent Application Publication
(10) Pub. No.: US 2016/0212465 A1
(43) Pub. Date: Jul. 21, 2016

(54) PREFERENCE CHANNEL SETTING APPARATUS AND METHOD OF SETTING THE PREFERENCE CHANNEL

(71) Applicant: SAMSUNG ELECTRONICS CO., LTD., Suwon-si (KR)

(72) Inventor: Wan-su KIM, Anyang-si (KR)

(73) Assignee: SAMSUNG ELECTRONICS CO., LTD., Suwon-si (KR)

(21) Appl. No.: 15/003,433

(22) Filed: Jan. 21, 2016

(30) Foreign Application Priority Data
Jan. 21, 2015 (KR) 10-2015-0010023

(51) Int. Cl. H04N 21/258; H04N 21/466; H04N 21/4223; H04N 21/4415; H04N 21/81; H04N 21/41; G06K 9/00; H04N 21/4782; H04N 21/25; H04N 21/858

(52) U.S. Cl. CPC H04N 21/25891; H04N 21/251; H04N 21/4667; H04N 21/4223; H04N 21/8586; H04N 21/8173; H04N 21/4126; G06K 9/00288; H04N 21/4782; H04N 21/4415

(57) ABSTRACT

A method and apparatus for setting a preference channel includes recognizing a user watching content of the broadcasting channel; determining a service condition of a mobile device of the user while the content of the broadcasting channel is playing; and setting a preference channel of the user based on the service condition of the mobile device.

### CROSS-REFERENCE TO RELATED APPLICATION

This application priority from Korean Patent Application No. 10-2015-0010023, filed on Jan. 21, 2015, in the Korean Intellectual Property Office, the disclosure of which is incorporated herein by reference in its entirety.

### BACKGROUND

1. Field

Apparatuses and methods consistent with exemplary embodiments relate to automatically setting preference channels of a user among broadcasting channels.

2. Description of the Related Art

A few hundreds of broadcasting channels are provided in digital broadcast. Thus, the selection of a program is further complicated while the selection choices are widened.

To speed up a complex process of channel selection, a preference broadcasting channel list may be provided. For example, broadcasting channels or programs that are frequently watched by a user may be set as preference channels, and may be provided as a preference broadcasting channels.

There is a demand for technology for providing a preference broadcasting channel list that is suitable for the viewing preferences of the user.

### SUMMARY

Provided is a method of setting a preference channel and a preference channel setting apparatus to enhance the efficiency of broadcasting channel management by providing an effective preference channel setting method.

Additional aspects will be set forth in part in the description which follows and, in part, will be apparent from the description, or may be learned by practice of exemplary embodiments.

According to an aspect of an exemplary embodiment, there is provided a preference channel setting apparatus including: a sensor configured to recognize a user watching content of a broadcasting channel; a network interface configured to determine a service condition of a mobile device of the user while the content of a broadcasting channel is playing; and a controller configured to set a preference channel of the user based on the service condition of the mobile device of the user.

The controller may be further configured to determine a number of actual watching times of the broadcasting channel of the user based on the service condition of the mobile device, and set the preference channel of the user based on the number of actual watching times.

The controller may be further configured to determine actual watching hours of the broadcasting channel of the user based on the service condition of the mobile device, and set the preference channel of the user based on the actual watching hours.

The sensor may be further configured to capture an image of the user while content of the broadcasting channel is playing, and the preference channel of the user may be set based on the image of the user.

The controller may be further configured to set the preference channel of the user based on the image of the user and the service condition of the mobile device of the user.

The network interface may be further configured to recognize the mobile device of the user through a network, and in response to the mobile device not being registered, transmit a uniform resource locator (URL) for installing an application to the mobile device and register the mobile device in which the application is installed, and determine the service condition of the mobile device through the application.

The network interface may be further configured to determine at least one of whether an internet browser is being used, whether a mobile game is playing, and whether a display of the mobile device is being touched, through the application while the content of the broadcasting channel is playing, and determine the service condition of the mobile device based on the at least one of whether the internet browser is being used, whether the mobile game is playing, and whether the display of the mobile device is touched.

The sensor may be further configured to capture an image of the user, recognize at least one of a face and a weight of the user based on the image of the user, and recognize the user based on the at least one of the recognized face and the weight of the user.

The sensor may be further configured to recognize a voice of the user, and recognize the user based on the voice of the user.

The network interface may be further configured to recognize the mobile device of the user through a network, and in response to the mobile device not being registered, transmit a uniform resource locator (URL) for installing an application to the mobile device, register the mobile device in which the application is installed, and recognize the user of the registered mobile device.

The preference channel setting apparatus may further include a memory configured to generate and store a preference channel list of the user, and the controller may be further configured to update the preference channel list based on the preference channel of the user.

The sensor may be further configured to re-recognize a user watching content of a broadcasting channel, and the preference channel setting apparatus may further include an output that provides a preference channel list to the re-recognized user.

The sensor may be further configured to recognize a plurality of users watching content of the broadcasting channel, the network interface may be further configured to determine the service condition of the mobile device of each user among the plurality of users while content of the broadcasting channel is playing, and the controller may be further configured to set a preference channel of each user among the plurality of users based on the service condition of each mobile device of each user among the plurality of users.

According to an aspect of another exemplary embodiment, there is provided a method of setting a preference channel, the method including: recognizing a user watching content of a broadcasting channel; determining a service condition of a mobile device of the user while the content of a broadcasting channel is playing; and setting a preference channel of the user based on the service condition of the mobile device of the user.

The setting the preference channel may further include: determining a number of actual watching times of the broadcasting channel of the user based on the service condition of the mobile device; and setting the preference channel of the user based on the number of actual watching times.

The setting the preference channel of the user may further include: determining actual watching hours of the broadcasting channel of the user based on the service condition of the mobile device; and setting the preference channel of the user based on the actual watching hours.

The determining the service condition of the mobile device of the user may further include: recognizing the mobile device of the user through a network; in response to the mobile device being not registered, transmitting a uniform resource locator (URL) and installing an application to the mobile device, and registering the mobile device; and determining the service condition of the mobile device through the application.

The determining the service condition of the mobile device of the user may include: determining at least one of whether an internet browser is being used, whether a mobile game is playing, and whether a display of the mobile device is touched, through the application while the content of the broadcasting channel is playing, and determining the service condition of the mobile device based on the at least one of whether the internet browser is being used, whether the mobile game is playing, and whether the display of the mobile device is touched.

The recognizing the user may include recognizing a plurality of users watching the content of the broadcasting channel, wherein the determining the service condition of the mobile device may include determining the service condition of the mobile device of each user among the plurality of users while the content of the broadcasting channel is playing, and wherein the setting the preference channel of the user may include setting the preference channel of each mobile device of each user among the plurality of users based on the service condition of each mobile device of each user among the plurality of users.

According to an aspect of another exemplary embodiment, there may be provided a computer readable recording medium having recorded thereon a method of setting a preference channel.

### BRIEF DESCRIPTION OF THE DRAWINGS

These and/or other aspects will become apparent and more readily appreciated from the following description of exemplary embodiments, taken in conjunction with the accompanying drawings in which:

FIGS. 1A and 1B are schematic drawings illustrating a preference channel list according to an exemplary embodiment;

FIGS. 2A and 2B are conceptual drawings illustrating an actual watching hour that is a basis in setting preference channels, according to an exemplary embodiment;

FIG. 3 is a block diagram of a preference channel setting apparatus according to an exemplary embodiment;

FIG. 4 is a flowchart illustrating a method of setting a preference channel according to an exemplary embodiment;

FIG. 5 is a flowchart illustrating a process of determining a service condition of a mobile apparatus according to an exemplary embodiment;

FIG. 6 is a flowchart illustrating a method of setting a preference channel according to an exemplary embodiment;

FIGS. 7A and 7B are conceptual drawings illustrating the determination of the number of actual watching times and actual watching hour of a user by using an image photographed by a sensor;

FIG. 8 is a block diagram showing a configuration of a preference channel setting apparatus according to an exemplary embodiment;

FIG. 9 is a conceptual drawing of a scene in which a plurality of users watch content of a broadcasting channel on a TV;

FIG. 10 is a flowchart illustrating a method of setting a preference channel for each user of plural users, according to an exemplary embodiment;

FIG. 11 is a flowchart illustrating a method of setting preference channels according to another exemplary embodiment; and

FIG. 12 is a flowchart illustrating a method of setting preference channels according to another exemplary embodiment.

### DETAILED DESCRIPTION

Reference will now be made in detail to one or more exemplary embodiments, examples of which are illustrated in the accompanying drawings, wherein like reference numerals refer to like elements throughout. The following descriptions include features to facilitate an understanding of one or more exemplary embodiments. Also, if a practical description with respect to a known function or configuration would be unnecessarily confusing, the descriptions thereof may be omitted.

Terms used for describing exemplary embodiments are briefly explained below. A preference channel is a broadcasting channel that the user prefers, and denotes all channels including real-time broadcasting channels and video on-demand (VOD) content broadcasting channels (e.g., programs). The registration and management of the preference channels may include a registration and management of the real-time broadcasting channels and the VOD content broadcasting channels.

When a user selects a “preference program” in a selection menu of a television (TV), related broadcasting channels may be recommended based on the watching history of the user. However, in a related method of, when a user watches a channel for only about 10 minutes, the corresponding channel is recommended as a preference channel for the user. That is, when simply a content of a broadcasting channel is repeated in a TV, the channel is registered as a user's preference channel, and thus, an unwanted broadcasting channel is recommended.

Therefore, in a case in which a user habitually turns on a TV as he gets home, a case in which the user plays a mobile game while turning on the TV, and a case in which the user turns on the TV to enjoy the sound of TV is repeated, the preference channels of the user may not be appropriately recommended.

Below, a method of setting preference channels according to an exemplary embodiment will be described in detail with reference to the accompanying drawings.

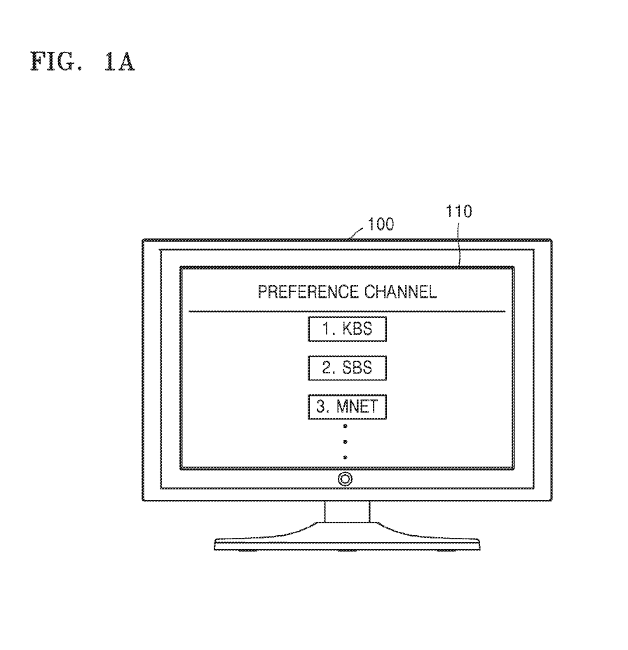

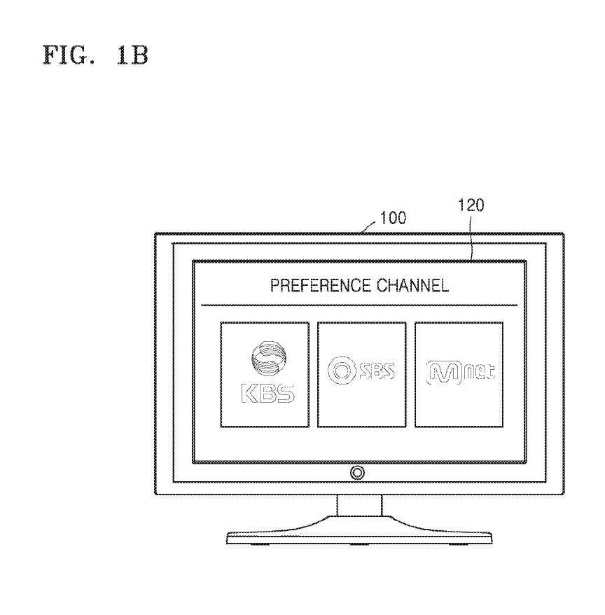

FIGS. 1A and 1B are schematic drawings illustrating a preference channel list according to an exemplary embodiment.

Referring to FIG. 1A, a preference broadcasting channel list 110 according to an exemplary embodiment is depicted. The preference broadcasting channel list 110 is displayed as a list type according to a designated priority. The priority designated preference broadcasting channel list 110 may be, for example, a list of preference broadcasting channels automatically selected by a preference channel setting apparatus according to an exemplary embodiment.

Referring to FIG. 1B, a preference broadcasting channel list 120 displayed as a thumb nail type, according to an exemplary embodiment, is depicted. In FIGS. 1A and 1B, two types of preference broadcasting channel lists 110 and 120 are shown. However, the preference broadcasting channel lists are not limited thereto. That is, different types of preference broadcasting channel list may be provided. Also, three broadcasting channels (e.g., KBS, SBS, and MNET) are depicted, but the broadcasting channels are not limited thereto.

A preference broadcasting channel list may include a priority designated preference broadcasting channel list. The preference channel setting apparatus may determine the priority of preference broadcasting channels by taking into account the broadcasting channels that are frequently watched (e.g. the number of watching times) and the watching hours of the broadcasting channels by a user. The preference channel setting apparatus may then generate a preference broadcasting channel list based on the determined preference channels.

After generating the preference broadcasting channel list, the preference channel setting apparatus may update the preference broadcasting channel list by re-determining the priority of the preference channels in re-consideration of broadcasting channels that are frequently watched by the user and watching hours of the broadcasting channels.

The preference broadcasting channel list may include a preference broadcasting channel list in which the priority of broadcasting channels is not designated. The preference channel setting apparatus determines whether the broadcasting channel that is watching by a user is a preference channel in consideration of watching condition of the user when a content is playing, and may add or delete the broadcasting channel from the preference broadcasting channel list. The watching condition of the user is determined as normal when the user actually watches a content of a broadcasting channel and is determined as abnormal when the user does not actually watch a content of a broadcasting channel.

The preference broadcasting channel list that is generated and updated in consideration of the broadcasting channels that are frequently watched by the user and the watching hours of the broadcasting channels may recognize only the number of displays and displaying hours of the corresponding broadcasting channels, and may not recognize whether the user watched the content of the corresponding broadcasting channel.

For example, in the case in which the user plays a game on a mobile phone or sleeps while keeping a TV turned on to display a content of a corresponding broadcasting channel, a broadcasting channel registered on the preference broadcasting channel list may not be a user's preference channel.

Accordingly, the preference channel setting apparatus according to an exemplary embodiment may determine whether a broadcasting channel is a preference channel in consideration of the watching condition of the user, and may add the broadcasting channel to the preference broadcasting channel list.

Also, according to an exemplary embodiment, the preference channel setting apparatus may set a preference broadcasting channel list by assorting a watching time period (e.g., watching hour) and an actual watching time period (e.g., actual watching hour), and by assorting the number of watching times and the number of actual watching times.

The number of watching times may denote the accumulate number of watching times until the preference channel setting is completed when a user watches by selecting a predetermined broadcasting channel. For example, at a moment of setting a preference channel, if the user selects SBS which is one of broadcasting channels and watches it 511 times for more than a predetermined time period, the number of watching times with respect to SBS may be 511 times. However, the number of watching times may include the cases in which a content of SBS is selected on the TV, but the user does not actually watch it. Accordingly, to compensate the cases, preference channels may be set by using actual watching times by counting the cases that the user actually has watched.

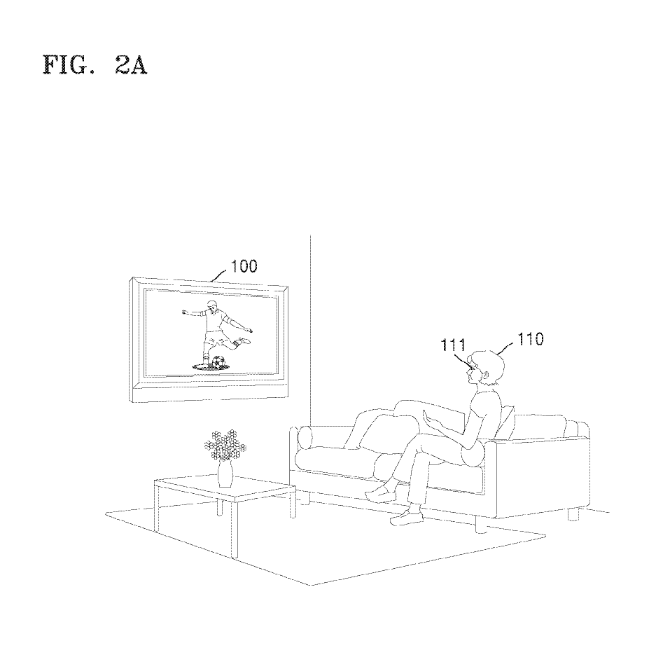

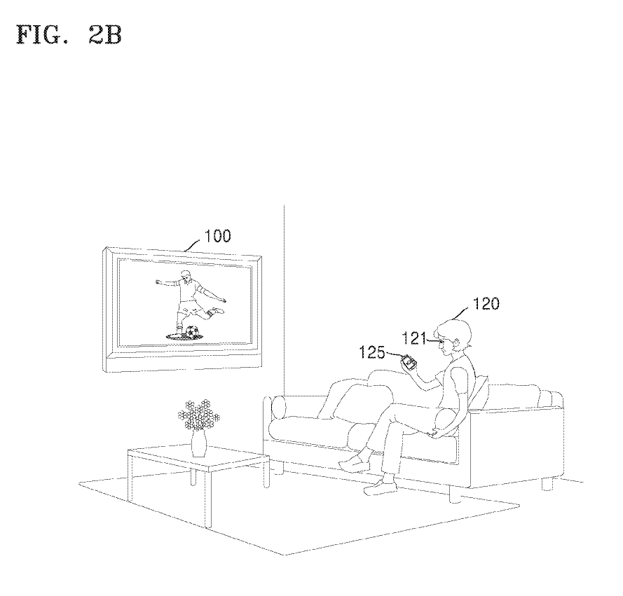

A TV watching hour may be generally the same as the displaying time of a content of a predetermined broadcasting channel. However, although a content of a broadcasting channel is playing, a user may watch a portion of the displaying content. Thus, an actual watching hour may be calculated by excluding hours for monitoring a mobile device or hours for averting a user's eyes from the TV. The number of actual watching times and the actual watching hours may be additionally described with reference to FIGS. 2A and 2B.

FIGS. 2A and 2B are conceptual drawings illustrating the number of actual watching times and actual watching hours in setting preference channels, according to an exemplary embodiment.

FIG. 2A shows a scene in which eye sight 111 of a user 110 actually watches displaying content of a broadcasting channel of a TV 100, and FIG. 2B shows a scene in which eye sight 121 of a user 120 is not actually watching displaying content of a broadcasting channel of the TV 100.

Referring to FIG. 2A, content of a predetermined broadcasting channel is playing on a TV 100, and the eye sight 111 of the user 110 faces the TV 100. The user 110 concentrates on the content of the broadcasting channel, and thus, it may be said that the user 110 actually watches the TV 100. At this point, the actual watching hour may be the same as the displaying hour of the content of the broadcasting channel. However, if the eye sight 111 of the user 110 faces other directions during displaying the content of the broadcasting channel, the actual watching hour may be less than the actual content displaying hour.

Referring to FIG. 2B, content of a predetermined broadcasting channel is in displaying on the TV 100, but the eye sight 111 of the user 120 faces a mobile device 125. Because the user 120 concentrates on the mobile device 125 and not the broadcasting channel, it may be that the user 120 is not actually watching the content of the broadcasting channel. At this point, the number of actual watching times of the content displaying broadcasting channel may not be changed. Thus, the actual watching hour may be different from the content displaying hour.

According to an exemplary embodiment, the number of actual watching times by a user with respect to a predetermined broadcasting channel may be determined based on a service condition of a mobile device of the user while the content of the predetermined broadcasting channel is playing.

The service condition of a mobile device may denote whether the mobile device is being operated by the user while content of a broadcasting channel is playing on a TV. For example, the service condition of a mobile device may be determined based on the cases of whether an internet browser of the mobile device is being used, whether a mobile game is used, or whether touches with respect to a display of the mobile device is continuously performed (e.g., touched) while content of the broadcasting channel is playing.

According to an exemplary embodiment, even though content of a predetermined broadcasting channel is displayed for two hours, if the user continuously plays a mobile game while the content of the predetermined broadcasting channel is displaying, it may be that the content of the predetermined broadcasting channel is not being watched. That is, the number of actual watching times of the predetermined broadcasting channel may not be added.

According to an exemplary embodiment, the number of actual watching times may be added when a user actually watches a broadcasting channel for more than a predetermined time period (e.g., hour). For example, if the predetermined time period is set to 10 minutes, an actual watching time may be added when the user actually watches the broadcasting channel for more than 10 minutes. It may not be necessary to satisfy continuously the predetermined time period, but if the user actually watches the broadcasting channel more than the predetermined time period while the content of the broadcasting channel is playing, the watching time may be added.

Also, according to an exemplary embodiment, an actual watching hour with respect to the predetermined broadcasting channel may be determined based on the service condition of the mobile device of the user while the content of the predetermined broadcasting channel is playing.

For example, even though the content of the predetermined broadcasting channel is displayed for more than two hours, if the user plays a mobile game for one hour while the content of the broadcasting channel is playing, it is determined that the mobile device is used for one hour, and the actual watching hour may be one hour.

Accordingly, the preference channel setting apparatus according to an exemplary embodiment may further correctly determine preference channels of the user by not counting an actual watching time with respect to a predetermined broadcasting channel or by reducing the actual watching hour with respect to the predetermined broadcasting channel in consideration of the service condition of a mobile device of the user regardless of the number of display times and displaying hours of the content of the predetermined broadcasting channel.

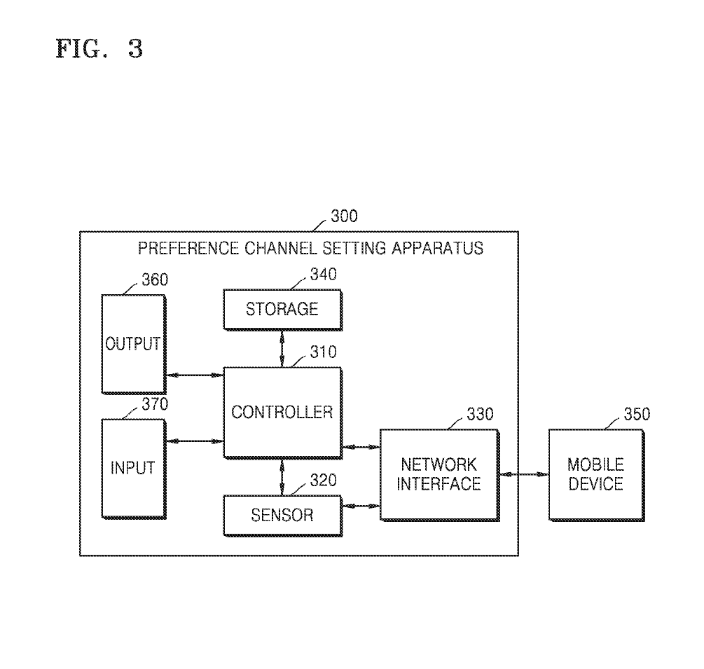

FIG. 3 is a block diagram of a preference channel setting apparatus according to an exemplary embodiment.

The preference channel setting apparatus may denote all devices that may be attached to a display apparatus including a set-top box of a digital TV that may display content of a broadcasting channel. For example, the preference channel setting apparatus may include all electronic devices that may be attached to a digital TV, a smart TV, an IP TV set-top box, and a TV or a set-top box, etc.

A preference channel setting apparatus 300 according to an exemplary embodiment may include a network interface 330, a storage 340 (e.g., memory), a controller 310, a sensor 320, an input 370, and an output 360 that are connected to a mobile device 350 via a wireless network.

The preference channel setting apparatus 300 may detect the service condition of the mobile device 350 by connecting to the mobile device 350 through the network interface 330. The network interface 330 may use Wi-Fi for wireless network communication with the mobile device 350. However, the communication of the network interface 330 with the mobile device 350 is not limited thereto. For example, communication with Bluetooth may also be used, etc.

Also, the output 360 may be an LCD or CRT display device like a TV, and may output an image data transmitted from the controller 310 on a screen. The output 360 may transmit the image data to an external device to display on the external device. The image data may include, for example, a preference channel list.

Also, the input 370 (e.g., a remote controller) may include a key for inputting data for receiving a broadcasting channel service. For example, the input 370 may include a preference channel key for registering or removing a predetermined broadcasting channel as a preference channel. The preference channel key may be a hot key for registering management of a predetermined broadcasting channel, and when data is inputted by using the preference channel key, a function of registering and removing broadcasting channels may be included in the preference channel key. The preference channel key may be a key included in a remote controller, or may include the function of the preference channel key in one of the existing keys.

The sensor 320 may sense a movement or a voice of a user. The sensor 320 may include, for example, a camera and a microphone. The sensor 320 may take a photograph of a user and may transmit it to the controller 310.

Also, the sensor 320 may sense and transmit a voice of a user to the controller 310. For example, when the user operates a TV orally, the sensor 320 may record and transmit the voice to the controller 310.

Also, according to another exemplary embodiment, the sensor 320 may recognize a user by analyzing an image or a voice.

The controller 310 may perform an overall control of the preference channel setting apparatus 300. The controller 310 may manually register a predetermined broadcasting channel as a preference channel. For example, if a user selects content of a predetermined broadcasting channel or if the user uses an input key for registering as a preference channel after selecting a predetermined broadcasting channel from a broadcasting channel list, the controller 310 may register the selected broadcasting channel as a preference channel. Also, the controller 310 may automatically set or update the preference channel based on an exemplary embodiment which will be described below.

The storage 340 is a memory space for storing user information or a preference channel list. The user information may be information for recognizing a user, and may include, for example, an image of the user or information of a mobile device of the user. The storage 340 may be operated in connection with the controller 310.

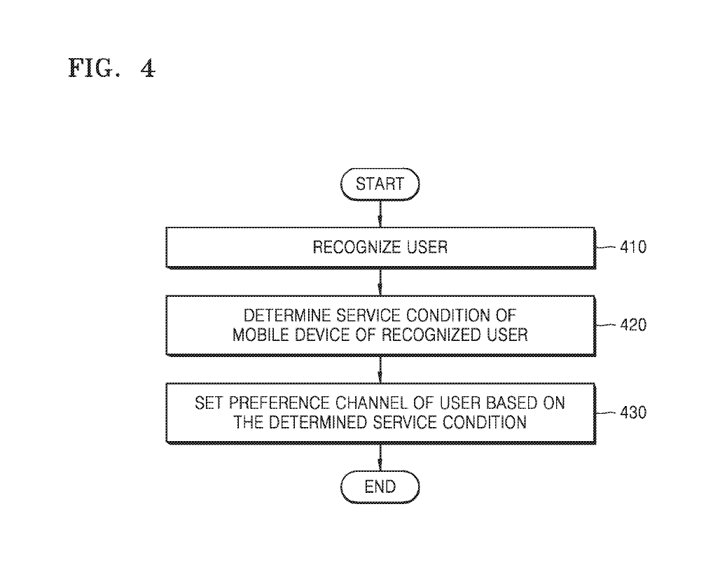

FIG. 4 is a flowchart illustrating a method of setting a preference channel according to an exemplary embodiment.

In an operation 410, the preference channel setting apparatus 300 may recognize a user who watches content of a broadcasting channel. The user recognition may denote an identification of a person who watches content of a broadcasting channel currently displaying on a TV.

The preference channel setting apparatus 300 according to an exemplary embodiment may recognize a voice of a user and may identify the user based on the voice of the user. When a user operates a digital TV or an IPTV set-top box orally, the preference channel setting apparatus 300 may recognize the user by comparing the voice of the user with a voice stored in advance.

The preference channel setting apparatus 300 according to an exemplary embodiment may recognize a user through a network of a mobile device of the user, and may recognize the user by using the mobile device.

After registering the mobile device having an application (App) that may connect the mobile device to the preference channel setting apparatus 300 in the preference channel setting apparatus 300, when the registered mobile device is recognized by a network interface, the preference channel setting apparatus 300 may recognize the user of the mobile device through the App.

If the mobile device is not registered on the preference channel setting apparatus 300, the preference channel setting apparatus 300 may transmit a URL for installing the App in the mobile device and may register the mobile device having the App.

Also, the preference channel setting apparatus 300 according to another exemplary embodiment may take a photograph of an image of a user. At this point, the preference channel setting apparatus 300 may recognize at least one of face and weight of the user from the image, and may identify the user based on at least one of the recognized face and weight of the user. For example, the preference channel setting apparatus 300 may store a plurality of user's faces in the storage 340 in advance, and may identify a user by comparing a user's face that is taken during displaying content of the broadcasting channel with the images stored in the storage 340.

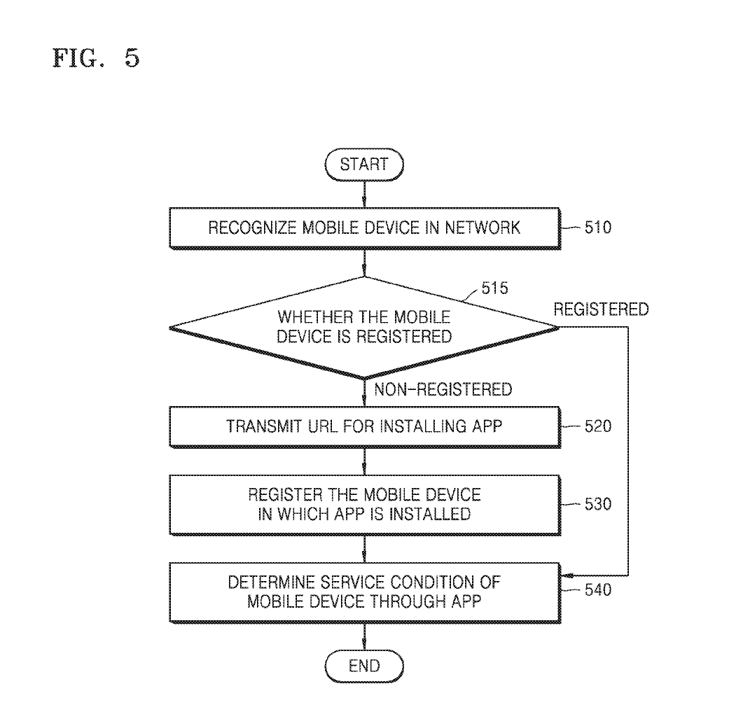

In an operation 420, the preference channel setting apparatus 300 may determine the service condition of a mobile device of the user while content of a broadcasting channel is playing, which will be described in detail with reference to FIG. 5.

In an operation 430, the preference channel setting apparatus 300 may set a preference channel of a user based on the service condition of a mobile device of the user while content of a broadcasting channel is playing.

For example, the preference channel setting apparatus 300 may determine at least one of the numbers of actual watching times and actual watching hours based on the service condition of the mobile device of the user while content of a broadcasting channel is playing.

For example, while content of a broadcasting channel is playing, if a mobile device of the user is continuously used or is used for hours exceeding a predetermined ratio with respect to the content display hour of the broadcasting channel, the watching hours may not be counted as actual watching hours.

Also, while content of a broadcasting channel is playing, an actual watching hour may be determined according to a ratio of using the mobile device of the user. For example, when the content of a broadcasting channel is playing for one hour and the mobile device of the user is used for 30 minutes during the time the content is displayed, the actual watching hour may be determined as 30 minutes.

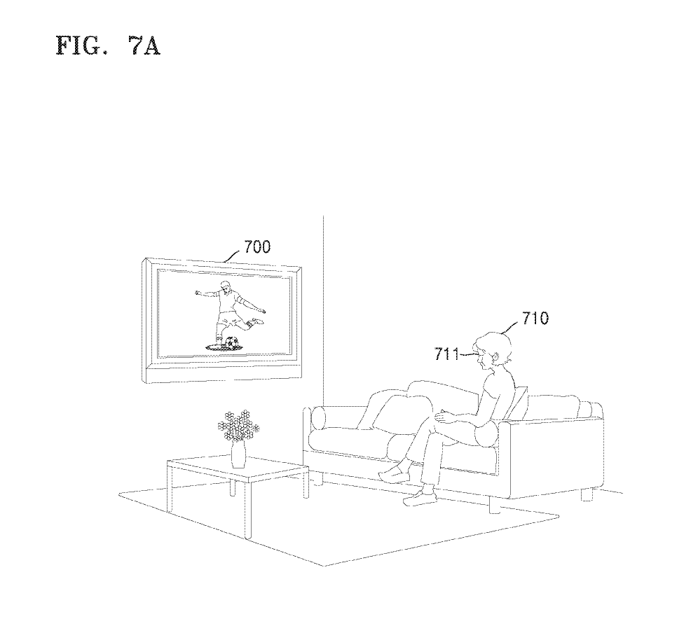

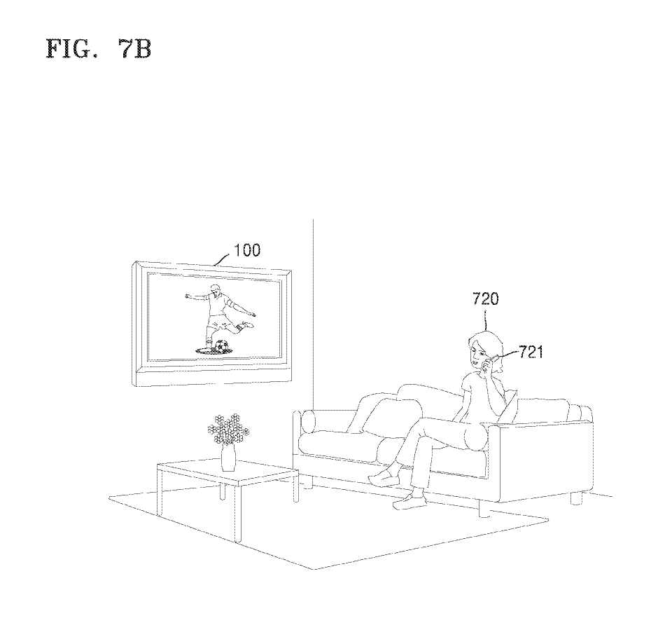

Also, the number of actual watching times and the actual watching hours of the user may be determined based on an image of the user while content of a broadcasting channel is playing, which will be additionally described with reference to FIGS. 7A and 7B.

According to an exemplary embodiment, the preference channel setting apparatus 300 may set a preference channel of the user based on at least one of the number of actual watching times and the actual watching hours.

The user's preference channel may be set by generating a preference channel list and updating the preference channel list based on at least one of the number of actual watching times and the actual watching hours with respect to the broadcasting channels.

For example, the preference channel setting apparatus 300 may include a broadcasting channel that has actual watching times that are more than a predetermined watching times in the preference channel list.

The preference channel setting apparatus 300 may include a broadcasting channel having an actual watching hour that is more than a predetermined watching hour in the preference channel list.

The preference channel setting apparatus 300 may set a priority order with respect to all broadcasting channels based on a score that is generated in a predetermined method in consideration of the number of actual watching times and the actual watching hours, and only a predetermined number of broadcasting channels that are in higher priority in the order may be included in the preference channel list.

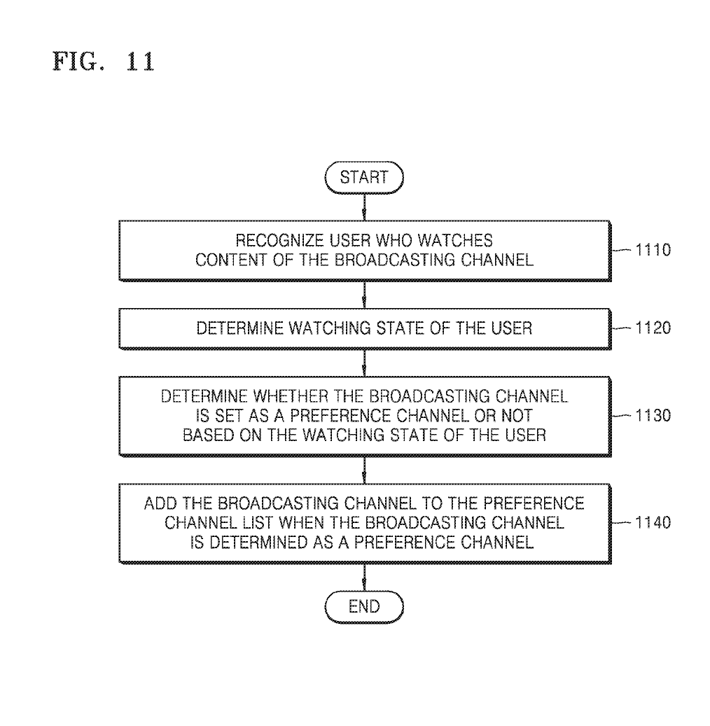

The above methods of selecting a preference channel are merely examples. Exemplary embodiments are not limited thereto. For example, another exemplary embodiment related to the selection of a broadcasting channel is illustrated in FIG. 11.

Also, the preference channel setting apparatus 300, after setting a preference channel list, may update the preference channel list by controlling the order of the corresponding broadcasting channels based on at least one of the number of actual watching times and the actual watching hours of the broadcasting channels at the moment of up-dating the preference channel list.

FIG. 5 is a flowchart illustrating a process of determining a service condition of a mobile apparatus according to an exemplary embodiment.

In an operation 510, the preference channel setting apparatus 300 may recognize a mobile device of a user through a network.

In an operation 515, it is determined whether the mobile device is registered with the preference channel setting apparatus 300.

In an operation 520, if the mobile device is not registered on the preference channel setting apparatus 300, the preference channel setting apparatus 300 may transmit a URL for installing an App to the mobile device.

In an operation 530, when the App is installed on the mobile device, the preference channel setting apparatus 300 may register the mobile device on the preference channel setting apparatus 300. The preference channel setting apparatus 300 may store information about the registered mobile device and the user information of the mobile device in the storage 340.

In an operation 540, if the mobile device was previously registered, the preference channel setting apparatus 300 may determine the service condition of the mobile device through the App. The preference channel setting apparatus 300 may contact the mobile device 350 through the network interface 330, and the App installed on the mobile device 350 transmits usage information of the mobile device 350 to the preference channel setting apparatus 300 Thus, the service condition of the mobile device 350 may be identified.

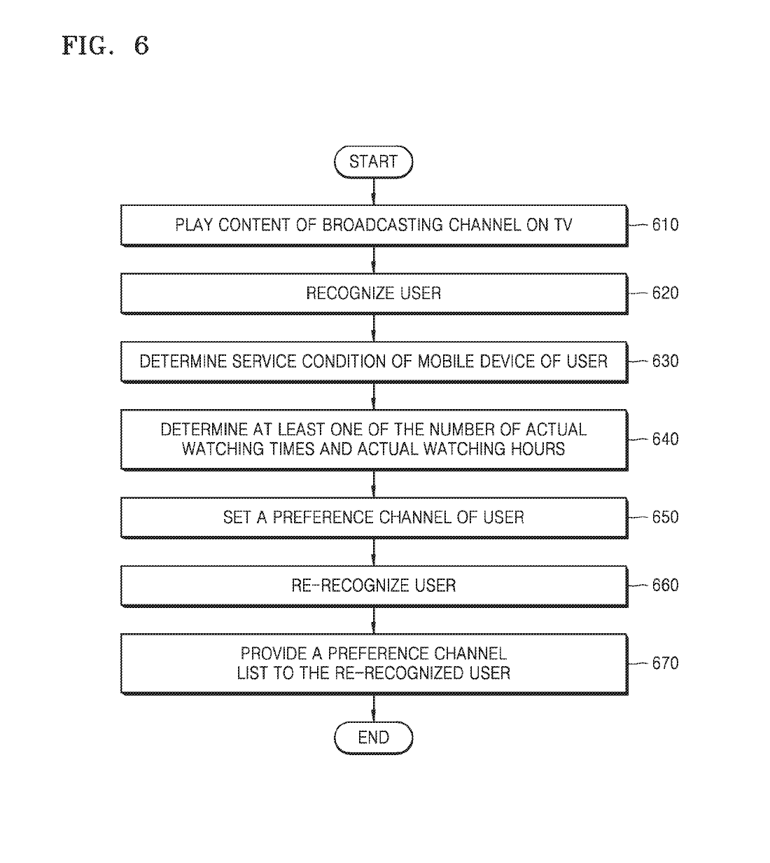

FIG. 6 is a flowchart illustrating a method of setting a preference channels according to an exemplary embodiment.

In an operation 610, content of a broadcasting channel is displayed on a TV. The broadcasting channel on the TV may be selected and inputted by a user.

In an operation 620, the preference channel setting apparatus 300 may recognize a user who watches the content of the broadcasting channel. In an operation 630, the preference channel setting apparatus 300 may determine the service condition of the mobile device 350. In an operation 640, the preference channel setting apparatus 300 may determine at least one of a number of actual watching times and an actual watching hour with respect to the broadcasting channel. In an operation 650, the preference channel setting apparatus 300 may set a preference channel of the user.

In an operation 660, the preference channel setting apparatus 300 may re-recognize the user. When the user is re-recognized, the preference channel setting apparatus 300 may retrieve a predetermined preference channel list of the user from the storage 340. For example, after the preference channel setting apparatus 300 generates a preference channel list with respect to a predetermined user by setting a preference channel of the predetermined user and stores it in the storage 340, if the predetermined user is re-recognized, the preference channel list with respect to the predetermined user may be retrieved from the storage 340.

In an operation 670, the preference channel setting apparatus 300 may provide the preference channel list to the re-recognized user. The preference channel list may be provided to the re-recognized user as the type of preference channel list of FIGS. 1A and 1B through the output 360 of the preference channel setting apparatus 300. Also, the preference channel setting apparatus 300 may transmit the preference channel list to an external device connected to the preference channel setting apparatus 300.

FIGS. 7A and 7B are conceptual drawings illustrating the determination of the number of actual watching times and the actual watching hours of a user by using an image photographed by the sensor 320.

Referring to FIG. 7A, content is playing on a TV 700, but the user 710 is sleeping.

Referring to FIG. 7B, content of a broadcasting channel is displayed on the TV 700. However, eyesight 711 of the user 720 is not facing the TV 700 but the user 720 is talking over a mobile device 721.

In the two cases described above, it may be difficult to determine whether the user is actually watching a predetermined broadcasting channel by using only the mobile device 721.

In this case, the preference channel setting apparatus 300 may determine whether the user is actually watching a predetermined broadcasting channel by using an image photographed by the sensor 320.

The number of actual watching times and the actual watching hours with respect to a predetermined broadcasting channel of a user may be determined based on an image of the user while content of a broadcasting channel is playing. For example, the preference channel setting apparatus 300 may take an image of the user while content of a broadcasting channel is playing, and determine at least one of the numbers of actual watching times and the actual watching hours with respect to the broadcasting channel by using the image of the user.

For example, the preference channel setting apparatus 300 may recognize the image by using a mechanical learning method. The preference channel setting apparatus 300 may learn images of watching the broadcasting channel and images of not watching the broadcasting channel by using a plurality of learning images, and may determine whether a user is watching the broadcasting channel of the user through the images photographed by the sensor 320.

The preference channel setting apparatus 300 may determine whether the eyesight 711 of the user is facing the TV based on the image of the user while content of a broadcasting channel is playing. When the eyesight 711 of the user is not continuously facing the TV while content of a broadcasting channel is playing, the watching may not be included in the number of actual watching times.

For example, while content of a broadcasting channel is playing, if the hours for facing places other than the TV by the eyesight 711 of the user or hours for closing eyes is greater than the time for facing the TV, the hour with respect to the broadcasting channel may not be included in the number of actual watching times.

According to an exemplary embodiment, an actual watching hour with respect to a broadcasting channel may be determined based on the time spent facing the TV by the eyesight of the user while content of a broadcasting channel is playing. For example, even though the displaying hour of content of a broadcasting channel is one hour, if the eyesight of the user faces the TV for 30 minutes, the actual watching hour with respect to the broadcasting channel may be determined as 30 minutes.

According to an exemplary embodiment, the preference channel setting apparatus 300 may detect whether the user actually watches the broadcasting channel by using the service condition of the mobile device and all images photographed at the sensor 320. For example, even though the displaying hour of content of the broadcasting channel is one hour, if the user uses the mobile device for 30 minutes and falls in sleep for the remaining 30 minutes, the actual watching hour may be determined as 0 hours.

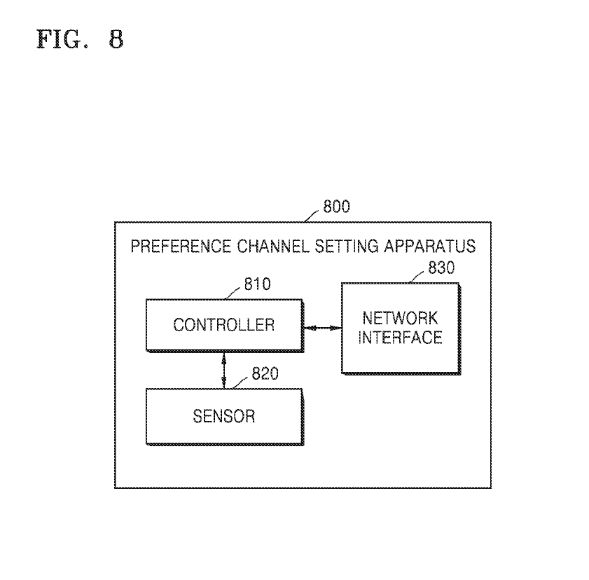

FIG. 8 is a block diagram showing a configuration of a preference channel setting apparatus 800 according to an exemplary embodiment.

The preference channel setting apparatus 800, according to an exemplary embodiment, may include a controller 810, a sensor 820, and a network interface 830.

The sensor 820 may correspond to the sensor 320 of FIG. 3. The sensor 820 may recognize a user who watches content of a broadcasting channel. The sensor 820 may recognize the user who watches the content of the broadcasting channel based on a voice or an image of the user.

The network interface 830 may correspond to the network interface 330 of FIG. 3. Also, the network interface 830 may determine the service condition of a mobile device of the user while content of a broadcasting channel is playing.

The controller 810 may correspond to the controller 310 of FIG. 3.

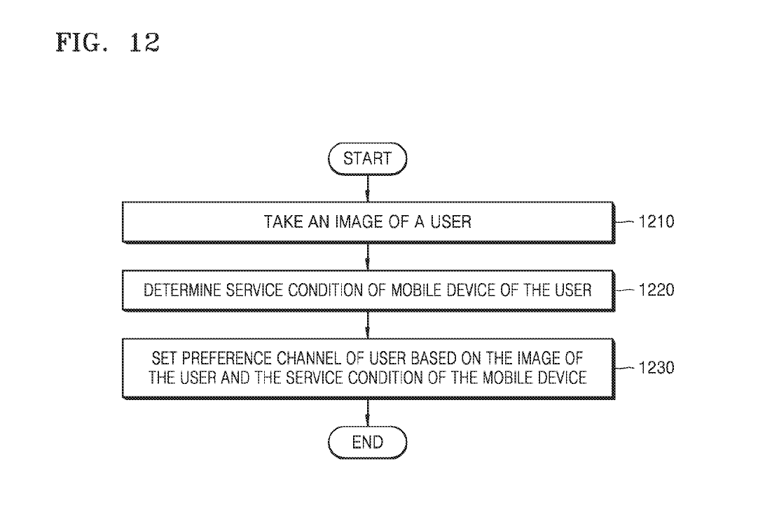

According to an exemplary embodiment, the controller 810 may determine a preference channel of the user based on the image of the user photographed by the sensor 820 and the service condition of the mobile device that is determined by the network interface 830, which will be described with reference to FIG. 12.

The controller 810 may determine at least one of the numbers of actual watching times and the actual watching hours of the user with respect to a broadcasting channel based on the display hours of the content and the service condition of the mobile device of the user. At this point, the controller 810 may set a preference channel of the user based on at least one of the determined actual watching times and the actual watching hours.

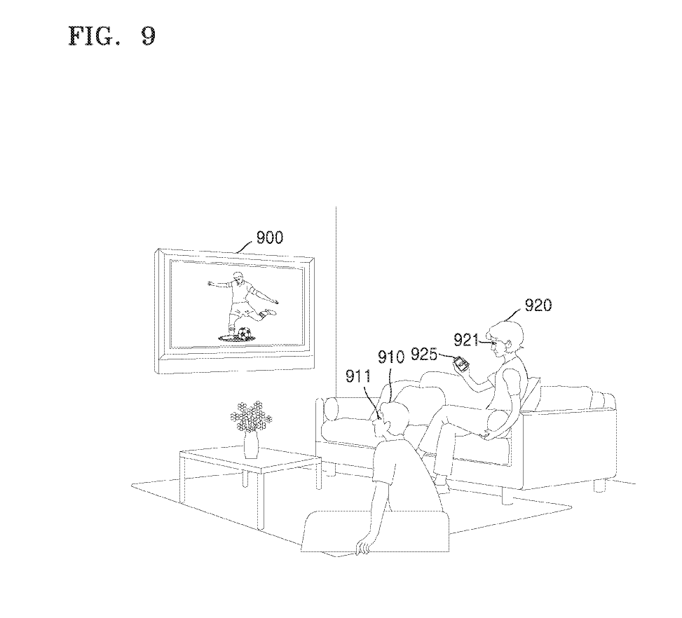

FIG. 9 is a conceptual drawing of a scene in which plural users 910 and 920 watch content of a broadcasting channel on a TV 900.

When there are plural users 910 and 920, the preference channel setting apparatus 300 may set preference channels with respect to each of the users 910 and 920 by recognizing the plural users 910 and 920.

Referring to FIG. 9, an eyesight 911 of one user 910 of the plural users 910 and 920 faces the TV 900, but an eyesight 921 of another user 920 faces a mobile device 925.

When a family watches a TV, some of them may be watching the TV but some of them may not be watching the TV although they are gathered in the same space. Therefore, it may be necessary to set a preference channel for each of the family members by determining the number of actual watching times and the actual watching hours of each of the family member.

According to an exemplary embodiment, the number of actual watching times and the actual watching hours with respect to a broadcasting channel of each of the plural users may be calculated by various methods. For example, the preference channel setting apparatus 300 may determine at least one of the number of actual watching times and the actual watching hours with respect to a broadcasting channel of each of the plural users based on the displaying hours of the content of the predetermined broadcasting channel and the service condition of a mobile device of each of the plural users, which will be described below.

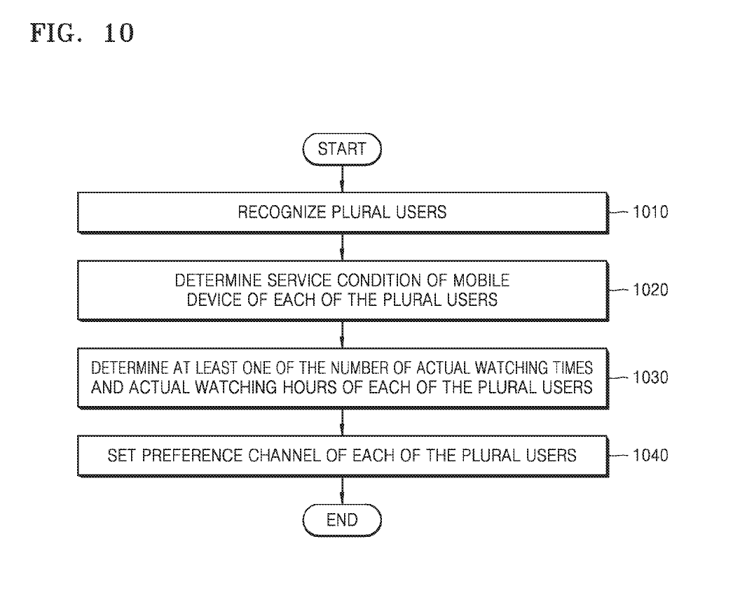

FIG. 10 is a flowchart illustrating a method of setting a preference channel of each user of plural users.

In an operation 1010, the preference channel setting apparatus 300 may recognize plural users who watch content of a broadcasting channel. For example, the preference channel setting apparatus 300 may recognize a first user and a second user who are registered in the preference channel setting apparatus 300 in advance through the sensor 320 and the network interface 330.

In an operation 1020, the preference channel setting apparatus 300 may determine the service condition of a mobile device of each user of the plural users while content of a broadcasting channel is playing on the TV.

For example, the preference channel setting apparatus 300 may determine that the mobile device of a first user is in use and the mobile device of a second user is not in use.

In an operation 1030, the preference channel setting apparatus 300 may determine at least one of the actual watching times and the actual watching hours of each of the plural users based on the service condition of the mobile device of each of the plural users.

Also, the preference channel setting apparatus 300 may determine at least one of the actual watching times and the actual watching hours of each of the plural users based on images after taking photographs of the plural users.

In an operation 1040, the preference channel setting apparatus 300 may set a preference channel of each of the plural users based on at least one of the actual watching times and the actual watching hours.

For example, the preference channel setting apparatus 300 may manage a preference channel of each of the plural users in a way that the preference channel setting apparatus 300 generates a preference channel list of the first user by setting the preference channel of the first user, and generate a preference channel list of a second user by setting the preference channel of the second user.

FIG. 11 is a flowchart illustrating a method of setting preference channels according to another exemplary embodiment.

In an operation 1110, the preference channel setting apparatus 300 may recognize a user who watches content of a broadcasting channel. The recognition of the user may denote the identification of a user who currently watches the content of the broadcasting channel of registered users.

Because the preference channel setting apparatus 300 may not recognize a user because the user is not registered, the preference channel setting apparatus 300 may perform a process for registering users. A user may be registered and recognized based on a user's image, a mobile device, or a voice. For example, the preference channel setting apparatus 300 may register a user by storing a face of the user through a camera of the sensor 320, by storing a voice analysis result by generating an oral production, or by storing information of a mobile device.

In an operation 1120, the preference channel setting apparatus 300 may determine the service condition of a user. The service condition of a user may denote whether the user is actually watching a currently displaying content of a broadcasting.

The watching condition of the user may be determined by at least one of the service condition of a mobile device of the user and an image of the user photographed while content of a broadcasting channel is playing.

In an operation 1130, the preference channel setting apparatus 300 may determine whether a broadcasting channel is set as a preference channel based on the watching state of the user. When it is determined that the user actually watches the content of a broadcasting channel that is currently playing, the broadcasting channel currently watching may be determined as a preference channel.

In an operation 1140, when the broadcasting channel that is currently playing is determined as a preference channel, the preference channel setting apparatus 300 may add the broadcasting channel that is currently playing in a preference channel list. When the broadcasting channel that is currently playing is not determined as a preference channel, that is, when it is determined that the user is not actually watching the broadcasting channel that is currently playing, the preference channel setting apparatus 300 may consider the broadcasting channel that is currently playing as a dummy broadcasting channel, and thus, may not add to the preference channel list.

FIG. 12 is a flowchart illustrating a method of setting preference channels according to another exemplary embodiment.

In an operation 1210, the preference channel setting apparatus 300 may take a photograph of a user in front of a TV. The preference channel setting apparatus 300 may recognize the user based on the photographed image of the user. At this point, the recognition of the user may denote the determination of the user currently located in front of the TV of the registered users.

In an operation 1220, the preference channel setting apparatus 300 may determine the service condition of a mobile device of the user.

In an operation 1230, the preference channel setting apparatus 300 may set a preference channel of the recognized user based on the image of the user and the service condition of the user. For example, when it is confirmed that the user is currently watching the TV in the photographed image and it is confirmed that the mobile device is not in use, the currently watching broadcasting channel may be registered as a preference channel.

Even though it is confirmed in the photographed image that the user is in front of the TV on which content is playing, if the mobile device is continuously in use, the broadcasting channel on which content is playing may be excluded from the preference channel of the user. For example, when the user is located in front of the TV but he plays a game on the mobile device, the currently watching channel may be excluded from the preference channel.

When it is confirmed that plural users are located in front of the TV on which content is currently playing, but mobile devices of some of the users are continuously in use, the broadcasting channel that is currently watched by the users may be excluded from the preference channel of some of the users. For example, when a first user and a second user are located in front of the TV, but the second user plays a game on the mobile device, the currently watching broadcasting channel may be registered as a preference channel of the first user, but may be excluded from the preference channel.

One or more exemplary embodiments can be written as computer programs and can be implemented in general-use digital computers that execute the programs using a computer readable recording medium.

Examples of the computer readable recording medium may include magnetic storage media (e.g., ROM, floppy disks, hard disks, etc.), optical recording media (e.g., CD-ROMs, or DVDs), and storage media such as carrier waves (e.g., transmission through the Internet).

While exemplary embodiments have been shown and described with reference to the drawings, it will be understood by those of ordinary skill in the art that various changes in form and details may be made therein without departing from the spirit and scope. The exemplary embodiments should be considered in a descriptive sense and not for purposes of limitation. The scope is defined by the appended claims.

What is claimed is:

1. A preference channel setting apparatus comprising:
a sensor configured to recognize a user watching content of a broadcasting channel;
a network interface configured to determine a service condition of a mobile device of the user while the content of a broadcasting channel is playing; and
a controller configured to set a preference channel of the user based on the service condition of the mobile device of the user.

2. The preference channel setting apparatus of claim 1, wherein the controller is further configured to determine a number of actual watching times of the broadcasting channel of the user based on the service condition of the mobile device, and set the preference channel of the user based on the number of actual watching times.

3. The preference channel setting apparatus of claim 1, wherein the controller is further configured to determine actual watching hours of the broadcasting channel of the user based on the service condition of the mobile device, and set the preference channel of the user based on the actual watching hours.

4. The preference channel setting apparatus of claim 1, wherein the sensor is further configured to capture an image of the user while content of the broadcasting channel is playing, and the preference channel of the user is set based on the image of the user.

5. The preference channel setting apparatus of claim 4, wherein the controller is further configured to set the preference channel of the user based on the image of the user and the service condition of the mobile device of the user.

6. The preference channel setting apparatus of claim 1, wherein the network interface is further configured to recognize the mobile device of the user through a network, and in response to the mobile device not being registered, transmit a uniform resource locator (URL) for installing an application to the mobile device and register the mobile device in which the application is installed, and determine the service condition of the mobile device through the application.

7. The preference channel setting apparatus of claim 6, wherein the network interface is further configured to determine at least one of whether an internet browser is being used, whether a mobile game is playing, and whether a display of the mobile device is being touched, through the application while the content of the broadcasting channel is playing, and determine the service condition of the mobile device based on the at least one of whether the internet browser is being used, whether the mobile game is playing, and whether the display of the mobile device is touched.

8. The preference channel setting apparatus of claim 1, wherein the sensor is further configured to capture an image of the user, recognize at least one of a face and a weight of the user based on the image of the user, and recognize the user based on the at least one of the recognized face and the weight of the user.

9. The preference channel setting apparatus of claim 1, wherein the sensor is further configured to recognize a voice of the user, and recognize the user based on the voice of the user.

10. The preference channel setting apparatus of claim 1, wherein the network interface is further configured to recognize the mobile device of the user through a network, and in response to the mobile device not being registered, transmit a uniform resource locator (URL) for installing an application to the mobile device, register the mobile device in which the application is installed, and recognize the user of the registered mobile device.

11. The preference channel setting apparatus of claim 1, further comprising a memory configured to generate and store a preference channel list of the user, and the controller is further configured to update the preference channel list based on the preference channel of the user.

12. The preference channel setting apparatus of claim 11, wherein the sensor is further configured to re-recognize a user watching content of a broadcasting channel, and the preference channel setting apparatus further comprises an output that provides a preference channel list to the re-recognized user.

13. The preference channel setting apparatus of claim 1, wherein the sensor is further configured to recognize a plurality of users watching content of the broadcasting channel, the network interface is further configured to determine the service condition of the mobile device of each user among the plurality of users while content of the broadcasting channel is playing, and the controller is further configured to set a preference channel of each user among the plurality of users based on the service condition of each mobile device of each user among the plurality of users.

14. A method of setting a preference channel, the method comprising:
recognizing a user watching content of a broadcasting channel;
determining a service condition of a mobile device of the user while the content of a broadcasting channel is playing; and
setting a preference channel of the user based on the service condition of the mobile device of the user.

15. The method of claim 14, wherein the setting the preference channel further comprises:
determining a number of actual watching times of the broadcasting channel of the user based on the service condition of the mobile device; and
setting the preference channel of the user based on the number of actual watching times.

16. The method of claim 14, wherein the setting the preference channel of the user further comprises:
determining actual watching hours of the broadcasting channel of the user based on the service condition of the mobile device; and
setting the preference channel of the user based on the actual watching hours.

17. The method of claim 14, wherein the determining the service condition of the mobile device of the user further comprises:
recognizing the mobile device of the user through a network;
in response to the mobile device being not registered, transmitting a uniform resource locator (URL) and installing an application to the mobile device, and registering the mobile device; and
determining the service condition of the mobile device through the application.

18. The method of claim 17, wherein the determining the service condition of the mobile device of the user comprises:
determining at least one of whether an internet browser is being used, whether a mobile game is playing, and whether a display of the mobile device is touched, through the application while the content of the broadcasting channel is playing, and
determining the service condition of the mobile device based on the at least one of whether the internet browser is being used, whether the mobile game is playing, and whether the display of the mobile device is touched.

19. The method of claim 15,
wherein the recognizing the user comprises recognizing a plurality of users watching the content of the broadcasting channel,
wherein the determining the service condition of the mobile device comprises determining the service condition of the mobile device of each user among the plurality of users while the content of the broadcasting channel is playing, and
wherein the setting the preference channel of the user comprises setting the preference channel of each mobile device of each user among the plurality of users based on the service condition of each mobile device of each user among the plurality of users.

20. A computer readable recording medium having recorded thereon a computer-readable program for executing the method of claim 14.
